(19) United States
(12) Patent Application Publication
(10) Pub. No.: US 2016/0194527 A1
(43) Pub. Date: Jul. 7, 2016

(54) COLD-SET BIOBASED LAMINATING ADHESIVE FOR PAPER OR PAPERBOARD PRODUCTS, AND PACKAGING MATERIALS

(71) Applicant: EcoSynthetix Inc., Burlington (CA)

(72) Inventors: Steven BLOEMBERGEN, Okemos, MI (US); Charles P. KLASS, Madeira Beach, FL (US)

(21) Appl. No.: 14/987,642

(22) Filed: Jan. 4, 2016

Related U.S. Application Data
(60) Provisional application No. 62/099,666, filed on Jan. 5, 2015.

(51) Int. Cl. C09J 11/08; B32B 29/00; B32B 7/02; B32B 7/12; C09J 11/04; C09J 103/04

(52) U.S. Cl. CPC C09J 11/08; C09J 11/04; C09J 103/04; B32B 7/02; B32B 7/12; B32B 29/005; B32B 2255/12; B32B 2255/26; B32B 2439/00

(57) ABSTRACT

This specification relates to cold-set biobased adhesive compositions, comprising aqueous formulations of biopolymers, optionally with alkaline additives, optionally fortified with high-aspect-ratio inorganic and organic fillers, fibers and nanofibers, optionally with barrier-inducing additives. The adhesive may be used, for example, as a cold-set, preferably biobased, laminating adhesive. In particular, the laminating adhesive may be used to create liner and/or medium paperboard products for light-weight paperboard and corrugated boxboard materials that, in some examples, have enhanced strength and/or barrier properties as compared with similar weight paperboard products. These laminated paperboard and corrugated boxboard materials are used, for example, as light weight packaging materials that are compatible with paper recycling and composting operations. In the context of this abstract, the term “lamination” or “laminating” relates to the adhesion of two flat (rather than pre-corrugated) paper surfaces, i.e. the gluing together of two continuous sheets of paper or liner or medium paperboard.

### CROSS-REFERENCE TO RELATED APPLICATIONS

This application claims the benefit of U.S. Application Ser. No. 62/099,666, filed Jan. 5, 2015. U.S. Application Ser. No. 62/099,666 is incorporated by reference.

### FIELD

This specification relates to laminating adhesives for paper or paperboard and to packaging materials.

### BACKGROUND

In today's corrugating and laminating industries, the most common adhesives used for corrugating are starch based, typically referred to as “Stein Hall” glues, which require heat to set the adhesive bond (specifically heat to raise the glue above the gel point temperature of starch), while the most common laminating adhesives are synthetic petroleum-derived cold-set latex adhesives (which are film-formers and require no heat added to set the adhesive, although heat may be used, for example, to decrease drying time or to adjust the final moisture level of the product). In corrugating operations, a medium and a liner are glued together using a “corrugating adhesive” (such as a starch based “Stein Hall” glue) via the flute tips of the corrugated medium onto the first liner in a single face corrugating operation and onto the second liner in the double facer (also referred to as ‘double backer’) operation. Significant heat is required to paste the starch and affect the adhesive bond. The term “lamination” or “laminating adhesive” sometimes relates to the adhesion of two or more flat surfaces, i.e. the gluing together of two or more continuous sheets of liner board with a layer of adhesive applied substantially across the entire area of one or more of the laminated sheets. However, the term lamination is also frequently used for operations that are similar to corrugating, but without the use of heat. One example is in-line laminating, sometimes also called Asitrade Laminating, where petroleum based cold set latex adhesives are used and the operation has a roll/press section, in place of the double backer and ‘hot plates’ oven section used in corrugating, to provide the required contact time to set the adhesive bond without the application of heat.

Corrugated board is produced through the corrugating operation. Corrugating is carried out by passing a corrugating medium through the corrugator, whereupon intermeshed corrugated rolls impart a corrugated profile to the medium. Adhesive is applied to the tips of the medium (on one side) and a liner board is applied onto the side of the medium with the adhesive to form a single face. By adding additional adhesive to the unglued side of the medium, an additional layer of liner board can be adhered onto the single face, resulting in the production of a standard single wall corrugated board. A more detailed description of corrugating and corrugating adhesives can be found in “Preparation of Corrugating Adhesives”, W. O. Koeschell, Ed., Technical Association of the Pulp and Paper Industry, Inc., 1977. There are many variations and multiple wall boards that can be constructed in the same general manner as described above by combining successive single face boards to each other, followed by a final application of a liner board. The adhesive used in corrugating plays an important role in the strength, quality and production efficiency of single face and single (and multiple) wall corrugated boards.

The concept of cooking starch in situ was first mentioned by Lawrence L. Dreurden who developed a double facer corrugator section for Robert Gair Co., which was patented in 1899. However, the concept was not commercially developed until after the 1936 patent by Jordan V. Bauer of Stein Hall Co., who conceived of the process that led to broad acceptance of starch as a corrugating adhesive. This process consisted of a novel manner of using a starch adhesive where high temperatures are used to form the bond after the adhesive film has been applied. The starch adhesive principle is based on the suspension of raw, uncooked starch, by a cooked starch carrier. The carrier provides sufficient viscosity or body to allow deposition of the adhesive film on the corrugated flutes. As the combined line is subjected to high heat of the corrugating operation, the uncooked starch on the adhesive line gelatinizes to form the adhesive bond. Today, this is still the dominant technology for corrugated board manufacturing.

Traditional starch adhesives used in corrugating operations are usually comprised of two types of starch—carrier starch and slurry starch (Peter A. Snyder, Corrugating International, Vol. 2, No. 4, October 2000, pp-175-179.). The carrier starch is used as a means to carry the uncooked slurry starch component in the adhesive preparation and imparts the initial green bond or green tack in the corrugating operation. Carrier starch is prepared by cooking starch beyond its gel point in the presence of chemicals such as caustic soda and borax. Caustic soda and borax are both added to modify the gel temperature and final properties of the adhesive starch preparation. Upon addition to the corrugated board in the corrugating operation, the starch adhesive is further heated to the point at which the slurry starch is itself converted into adhesive starch, the remaining water is evaporated and the final dry bond is formed in the corrugated board. It is understood that for any conventional starch to be an adhesive, it must actually be in solution. Therefore, the carrier starch is the only true adhesive component in the corrugating adhesive preparation when the adhesive is applied in the corrugating operation (Snyder, ibid.). The slurry starch becomes an effective adhesive only when it reaches sufficient temperature, the gel point, in the corrugator.

Preparation of carrier/slurry type starch corrugating adhesives, which are sometimes also referred to as Stein Hall adhesives, is well known within the corrugating industry. The carrier starch component of a corrugating adhesive is usually only a fraction of the total starch used in the adhesive. Typically, carrier starch may represent 5-25% of the total starch added in preparing the adhesive. In addition, borax is added to make the typical carrier/slurry starch type adhesive mixture thicker, stickier, and tackier (Snyder, ibid.). More recently alternatives to borax have been introduced, especially in Europe, as it has come under increasing regulatory pressures. Caustic soda is added to the adhesive preparation in order to lower the gel point of the starch (effectively lowering the gelatinization temperature of the raw starch in the slurry starch). Caustic soda addition, therefore, improves the overall performance of the carrier/slurry starch type adhesive and is considered an integral part of the typical corrugating adhesive in the context of a traditional Stein-Hall process.

A typical industrial corrugator requires significant energy input in order to heat the corrugated board to a sufficient temperature to gel the starch and to remove enough water to create the final dry bond (typically at temperatures of about 180° C. or 350° F. in the double backer).

U.S. Pat. No. 4,279,658 describes the process for preparation of a starch paste via chemical-mechanical starch conversion. The starch is gelatinized at production sites where thermal energy is not available and is prepared through the use of mechanical shear subjected to a slurry in the presence of alkali. The resulting paste is described as stable and does not require further gelatinization prior to incorporation into adhesive formulations. The drawback of adhesives prepared with this paste is that they must still be gelatinized on site for use in corrugating adhesive applications. Also, it is obvious that application of such an adhesive requires gelatinization to occur in the corrugator in order for the adhesive preparation to properly function. This will require that the corrugating equipment be operated in such a manner as to insure that gelatinization will occur in the operation, as typically done with standard corrugating adhesives.

U.S. Pat. No. 5,855,659 describes an instant corrugating adhesive that supposedly does not require cooking and can be re-hydrated under ambient conditions. This adhesive is prepared by first making a dry blend of native starch (uncooked) and a hemicellulose. The hemicellulose is capable of being easily re-hydrated and therefore functions as the carrier phase for the uncooked starch and, therefore, resembles a standard Stein Hall type corrugating adhesive. One drawback of this adhesive is that the hemicellulose must first be extracted from a suitable source and then recovered from the extraction liquor, dried and mixed with the uncooked starch, which is a relatively complex method. The authors further describe that lumps may be formed upon re-hydration and an elevated temperature may therefore be required. This adhesive is also rather conventional in that it still functions as a Stein Hall type adhesive. It is obvious that this process requires gelatinization to occur in the corrugator in order for the adhesive preparation to properly function and, therefore, requires that the corrugating equipment be operated in such a manner as to insure that gelatinization will occur in the operation.

U.S. Pat. No. 3,444,109 A, published May 13, 1969 and entitled Paper Laminating Adhesive Compositions Comprising Protein-Containing Starch Material, describes paper corrugating adhesive compositions (even though it refers to them as “laminating adhesive”), certain of which are especially adapted for the bonding of corrugated board stock under commercial production conditions, such adhesive compositions require substantial heat to activate the main starch adhesive component (for example, the conditions used in Example 1 are heating on a hotplate held at 375° F. for 10 seconds), and further being characterized by a first reactant in the form of a finely divided, potentially adhesive, potentially viscoidal primary material having a protein content of at least about three percent by weight and an ungelatinized starch content of about fifty percent to about eighty five percent by weight, a second reactant which serves as a starch gelatinization agent and is a slightly water soluble alkaline earth metal hydroxide forming material such as lime, providing by chemical reaction with the protein of substantial water resistance in the resulting adhesive bond, and a third reactant in the form of a water soluble resin selected from the group consisting of amino-aldehyde liquid resins, ketone-aldehyde liquid resins, and mixtures thereof, such as urea-formaldehyde resin. Additive ingredients can also be employed, such as viscosity modifying agents, inorganic and organic filler materials, emulsive water propellants, wetting agents, and preservatives.

U.S. Pat. No. 3,336,246, published Aug. 15, 1967 and entitled Paper Laminating Adhesive Compositions Containing Resorcinol describes paper corrugating adhesive compositions (even though it refers to them as “laminating adhesive”), and claims certain advantages of lower heat requirements, but still require substantial heat to activate the starch adhesive component (for example, in their Example 1, the gelatinization temperature is specified as 140° F.).

As noted above, laminated board is sometimes produced through a process similar to that of producing corrugated board, but the distinguishing feature is the absence of heat used to cure the adhesive by raising the starch above its gel point temperature. Therefore, in contrast to the corrugating process described above, most laminating processes do not use the same starch adhesives.

The different types of laminating processes include in-line laminating (single face to liner), sheet-fed laminating (single face to liner), solid fiber laminating (liner to liner), dual arch laminating (medium to medium), bulk box laminating (combined corrugated board to corrugated board), label laminating (label to liner), and other laminating processes. In this regard, it should be appreciated that the term “substrate” is used herein to broadly refer to any object that can be laminated in either a corrugator or during a laminating process.

The in-line laminating process is the dominant process, and accounts for the majority of laminated board produced in the marketplace. It is similar to corrugating in producing the single face, but differs in its double facer operation. For example, in-line laminating produces, among other products, the type of colorful packaging that displays “point-of-sale” information on the outside of the box in high quality graphics printing (e.g., for electronics, toys, tools, pizza boxes, etc.). In order to protect the high color graphics, the gluing process is carried out at ambient temperatures, as opposed to the double facer in corrugating where the hot plates section is at about 350° F. As noted above, this heat in the corrugating process is required to gel the starch adhesive. Therefore, conventional starch based adhesives used in corrugating cannot be used in laminating.

Instead, other water-based adhesives are used in laminating, including water soluble adhesives and polymer colloids (i.e. aqueous latex dispersions) which require no heat to set the adhesive, although heat may be used, for example, to decrease drying time or adjust the final moisture level of the product. Water soluble adhesives include formulations of polyvinyl alcohol (PVOH) of varying degrees of hydrolysis (typically 88% to 98+%), dextrins (broad molecular weight oligomeric mixtures produced by degradation and/or thermal or chemical modification of starch), and other water soluble polymers. Synthetic, petroleum based adhesives have dominated the laminating industry. Most commonly these are high-solids water based dispersions of polymer colloids (i.e. aqueous latex dispersions), which contain particles with an average size range of less than about 2 μm. The most common type of adhesive used is a polyvinyl acetate (PVAc) “white glue”, which generally consists of a water based formulation at about 35 to 60% solids (note that the % solids is expressed on a “bone dry” basis), but in principle can be as high as the theoretical maximum of 72% solids. The solids concentrations used in laminating are generally higher than those used in corrugating. The high solids content allows at least an initial bond to occur instantly, or at least without significant drying time. Equipment to apply the adhesive in a laminating process is typically distinct from equipment used to apply adhesive in corrugating as a result, at least in part, of the need to operate in laminating with a high solids content cold-set adhesive.

The boxboard industry is accustomed to producing and using standard grades of medium and liner board products. The most common liner board grades include 26, 33, 38, 42, 69 and 90 lb/msf. The presentation (PDF file is available on line) by R. Popil, “What's important in liner and medium physical properties”, Institute of Paper Science, Georgia Tech, Atlanta, describes the typical strength properties for standard liner and medium board products and the common test methods used, including Short-Span Compression Test (SCT or CD-STFI) and Ring Crush.

### SUMMARY OF THE INVENTION

This specification relates to a laminating adhesive composition, comprising aqueous formulations of biopolymers, preferably selected from the group consisting of cooked soluble starch products, more preferably cooked soluble modified starch products, and most preferably dispersions of biopolymer nanoparticles, optionally with alkaline additives that are preferably selected from the group consisting of sodium carbonate, sodium hydroxide, sodium silicate, potassium hydroxide, ammonium hydroxide, calcium oxide, calcium hydroxide, calcium magnesium oxide, calcium magnesium hydroxide, sodium aluminum oxide, hydrated lime, dolomitic lime, dolime and any other natural alkaline mining materials, and optionally fortified with additives that are preferably selected from the group consisting of high-aspect-ratio inorganic and organic fillers, fibers and nanofibers, optionally with barrier-inducing additives that are preferably selected from the group consisting of crosslinkers, hydrophobizers and inorganic and organic barrier materials. The laminating adhesive composition is preferably cold-setting and preferably biobased.

This specification also describes the use of a laminating adhesive composition as described above to create liner and medium paperboard products such as liner and medium paperboard products, and corresponding methods and products. This specification also describes a laminated construct comprising two or more layers of substrate adhered to one another, each layer of substrate being 26 lb/msf or less.

Products or constructs as described herein may be used to provide packaging materials such as paperboard or corrugated boxboard materials. In various experimental examples described herein, these materials demonstrated enhanced strength and barrier properties as compared with similar or heavier weight conventional materials. In at least some cases, the products or constructs described herein are also compatible with paper recycling and composting operations.

### DESCRIPTION OF THE FIGURES

FIG. 1 provides a comparison of the Short-Span Compression Strength (STFI value) for (a) a single 100% recycled medium (13 lb/msf) paper sheet with two of the same sheets after being laminated with a biopolymer adhesive formulation, and (b) the 2-layer laminated sheet of (a) after being laminated again with a 16 lb/msf C1S litho label liner as a third layer; CD STFI Reference Values (20% recycled content) for 1) 14 lb medium, 2) 26 lb medium and 3) 42 lb liner (Source for Reference Values: R. Popil, “What's important in liner and medium physical properties”, Institute of Paper Science, Georgia Tech, Atlanta).

FIG. 2 is a schematic representation of light weighting through lamination: here a cereal box design is provided as an example, where multiple layers of paper are laminated together to create a stronger, lighter package optionally with no interior plastic pouch.

FIG. 3 illustrates the increase in Messmer Büchel Bending Resistance for fiberglass paper coated with biobased adhesive compositions containing biopolymer nanoparticles without and with either CNC or CNF; the advantage of using fiberglass paper is that the coat weight can be confirmed via a standard “Loss-On-Ignition” (LOI) method, given that the glass fiber is stable under ignition conditions at 550° C., whereas the organic coating is burned off such that the coat weight can be accurately determined.

FIG. 4 provides a comparison of Messmer Büchel Bending Resistance for 26 lb/msf liner board paper (left), 26 lb/msf liner board coated with a biobased adhesive composition containing biopolymer nanoparticles (middle), and 26 lb/msf liner board coated with a biobased adhesive composition containing biopolymer nanoparticles and CNC (right).

FIG. 5 is a photo of the applicator roll system, where (the grooved applicator rod is not visible) the huge increase in the CD bending stiffness demonstrated in FIG. 3 is believed to be the result of alignment of the high aspect ratio CNC rods in the CD direction, due to the applicator roll speed differential and the resultant wiping action created by the speed difference between the paper and the applicator roll system used to apply the aqueous adhesive composition.

FIG. 6 provides a comparison of the Ring Crush (left chart) and Short-Span Compression Strength (right chart) for 2-layer laminated constructs of 26 lb/msf liner board after being laminated with either a biopolymer adhesive formulation or with a petroleum based PVAc white glue.

FIG. 7 illustrates the shelf life stability for a biopolymer adhesive formulation containing various levels of an epoxy based crosslinker added to facilitate water resistance for the laminated construct.

### DETAILED DESCRIPTION

The boxboard industry is accustomed to standard grades of medium and liner board products. For all of these various grades the limits of strength are well known and understood, and these products are generally sold based on weight in pounds per msf (thousand square foot), or based on their caliper and recycled fiber content. These factors impact the limits of strength, as typically measured by Short-Span Compression Test (SCT or CD-STFI) and Ring Crush. The most common liner board grades include 26, 33, 38, 42, 69 and 90 lb/msf. Certain specialty grades also exist. The inventors have discovered that certain aqueous formulations including one or more biopolymers can serve as cold-set adhesives for producing laminated medium and liner board constructs from two or more substrates sheets, such as paper, medium and/or liner board sheets. At least some of these formulations have demonstrated excellent machine runnability, and some may offer increased strength in at least one direction relative to a comparative conventional adhesive. Optionally, one or more of these formulations can be used to produce a laminated sheet (i.e. substrate to substrate laminated construct) with higher stiffness, as measured by SCT CD-STFI and Ring Crush, when compared to the equivalent weight of standard paper, medium or liner board sheets. The invention thus can be used to provide one or more packaging materials. In some embodiments, the invention provides a means for producing a relatively light weight packaging structure. In general, reducing packaging weight or increasing biobased content in packaging can provide one or more associated environmental benefits (such as reduced fiber weight, reduced transportation and inventory, and improved recyclability and compostability). Notably these aqueous formulations of biopolymers were found to be capable of adhering the multiple sheets into the laminated constructs without the need for ovens or external heat sources, for example without the need to heat starch to above its gel point. In some embodiments, a laminated (i.e. non-corrugated) packaging material (for example a medium or liner board), for example of 26 or more lb/msf, is constructed with two or more sheets of substrate. In some cases at least two of these sheets of substrate would typically be considered to be a form of paper or medium rather than a liner board because they have a weight of less than 26 lb/msf.

This specification describes cold-set, preferably substantially biobased, laminating adhesive compositions, comprising aqueous formulations of one or more biopolymers, optionally with alkaline additives, optionally fortified with high-aspect-ratio inorganic and organic fillers, fibers and nanofibers, optionally with barrier-inducing additives. In some embodiments, such a laminating adhesive composition is used to create a stronger liner or medium paperboard product for a given weight relative to a conventional non-laminated material of the same weight. In some examples, paperboard and corrugated boxboard materials may have enhanced strength and/or barrier properties as compared with similar or heavier weight paperboard products produced using traditional manufacturing methods. These high-strength light-weight paperboard and corrugated board materials are used, for example, as light weight packaging materials and may be compatible with paper recycling and composting operations. In the context of this summary and the detailed description and claims to follow, unless noted otherwise, the term “lamination” or “laminating” refers to the adhesion of two or more generally flat (the word “flat” could include for example a sheet of substrate drawn from a roll or bending around a feed roller but is not meant unless stated otherwise to include a pre-corrugated substrate) substrate surfaces together, i.e., the gluing together of two or more initially non-corrugated and typically continuous sheets of paper, liner or medium paperboard, preferably with a substantially continuous layer of the adhesive applied to at least one of the substrate surfaces, although the laminated construct may be corrugated during or after lamination.

The laminating adhesive composition may comprise a dispersion, preferably a colloidal dispersion or latex, of biopolymer nanoparticles in water. International Publication Number WO 00/69916, entitled Biopolymer Nanoparticles, describes a process for producing biopolymer nanoparticles in which the biopolymer is plasticized using shear forces, a crosslinking agent being added during the processing. After the processing, the biopolymer can be dissolved or dispersed in an aqueous medium to a concentration between 4 and 40 wt %. This results in starch nanoparticles which are characterized by an average particles size of less than 400 nm.

International Publication Number WO 2008/022127, entitled Process for Producing Biopolymer Nanoparticles, describes a process for producing biopolymer nanoparticles in which biopolymer feedstock and a plasticizer are fed to a feed zone of an extruder having a screw configuration such that the biopolymer feedstock is processed using shear forces in the extruder, and a crosslinker is added to the extruder downstream of the feed zone. The temperatures in an intermediate section of the extruder are preferably kept above 100° C. The screw configuration may include two or more steam seal sections. Water may be added in a post reaction section located after a point in which the crosslinking reaction has been completed.

Some uses of the nanoparticles of U.S. Pat. No. 6,677,386 can be found in: (i) U.S. Pat. No. 7,160,420 which describes the use of the biopolymer nanoparticles as a wet-end additive in papermaking pulp slurry, or applied to the surface of the paper as a surface sizing agent; (ii) U.S. Pat. No. 6,825,252 which describes the use of the biopolymer nanoparticles in a binder in a pigmented paper coating composition; (iii) U.S. Pat. No. 6,921,430 which describes the use of the biopolymer nanoparticles in environmentally friendly adhesives; and (iv) U.S. Patent Application Publication No. 2004/0241382 which describes the use of the biopolymer nanoparticles in an adhesive for producing corrugated board.

US2013/0239849 mentions that the biobased latex binder of U.S. Pat. No. 6,677,386 provides performance that is comparable to SB and SA latex for important paper properties such as coating gloss, brightness, whiteness, fluorescence, ink gloss, and printability, while providing superior performance to SB and SA Latex for water retention, opacity, dry pick, print mottle, porosity (blister resistance) and paper stiffness.

All of the patents and other publications mentioned in the four paragraphs above are hereby incorporated by reference as if fully set forth herein. Other methods of making biopolymer nanoparticles may also be used. Dispersions of fragmented biopolymer (for example cross linked then fragmented starch granules) might also be used. Pre-gelatinized biopolymers such as starch, or biopolymers such as starch in chemically modified cold soluble forms might also be used.

As noted above, the most common liner board grades include 26, 33, 38, 42, 69 and 90 lb/msf. In some embodiments, packaging materials are created by laminating light weight papers, medium or liner board of up to about 26 lb/msf in order to produce laminated constructs that are useful for light weight packaging, i.e. that can meet one or more standards required for 26 lb/msf or higher liner board grades. Note further, that typical newsprint papers are about 8 lb/msf (or 40 gsm—the conversion factor from lb/msf to gsm being 4.88). Preferred papers or other substrates used in these embodiments can range from 4 to 26 lb/msf, and a more preferred range of papers used in this context ranges from 6 to 18 or from 8 to 16 lb/msf. In some cases, the laminated construct might weigh less than 26 lb/msf. Notably, the newsprint and light weight coated (LWC) paper industry has been in steady decline, with newsprint and LWC mills being shut down all over the world. In contrast, paper used in packaging has globally been enjoying steady growth. These embodiments, therefore, have the potential to provide a critical lifeline to newsprint and LWC mills by enabling them to repurpose their product lines and manufacturing assets to move into packaging markets, a growth and more lucrative sector of the paper industry. Still other embodiments enable the production of light weight high quality printable grades of packaging with high recycled content by laminating one or more layers of paper, medium and/or liner board with a printable medium such as a C1S (Coated One Side) label paper as the top and/or bottom layer. This then provides a white laminated construct with one or two high quality printable surfaces. In one embodiment of the invention, the white top is designed for high quality offset printing. In another embodiment of the invention, the white top is designed for high quality inkjet printing. In another embodiment of the invention, the white top is designed for high quality digital printing. In another embodiment of the invention, the white top is designed for high quality flexo printing. In yet another embodiment of the invention, the white top is designed for any other special type high quality printing method.

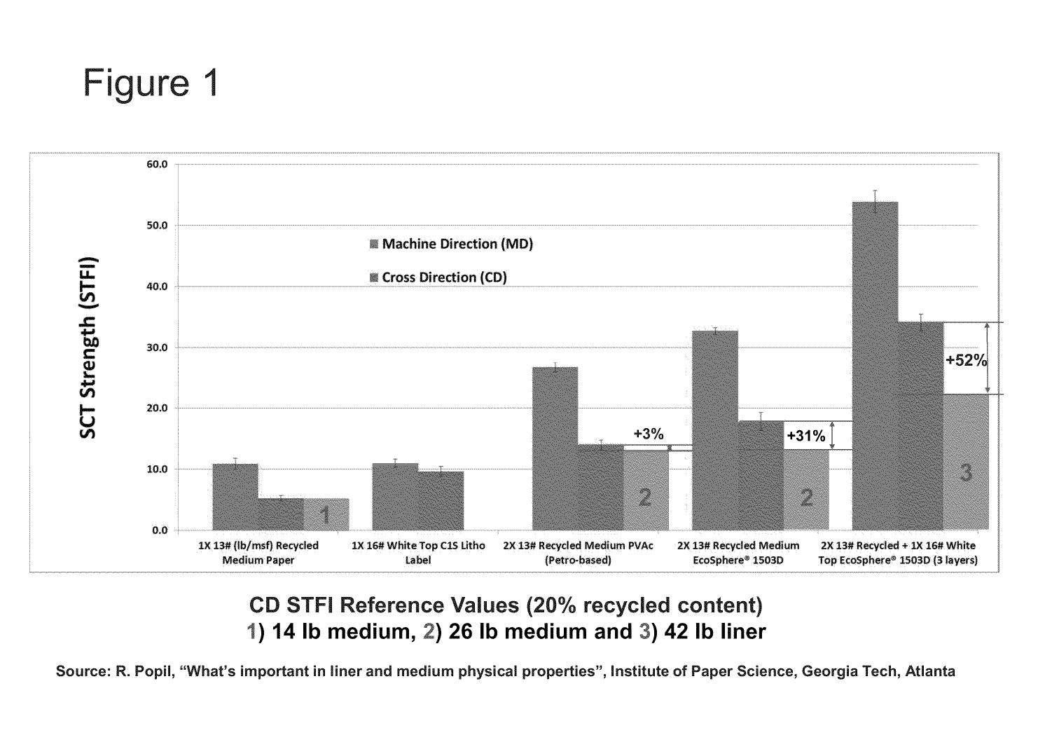

FIG. 1 provides a comparison of the Short-Span Compression Strength (STFI value) for (a) a single sheet of 100% recycled medium (13 lb/msf) with two of the same sheets after being laminated with a biopolymer adhesive formulation described in the specification. The results show a similar strength value of the 100% recycled medium (13 lb/msf) to a standard 14 lb/msf medium, but when laminated (13+13=26) a 31% increase in STFI strength was measured for the 2 layer construct over that of a standard 26 lb/msf liner. Note further that the standard 26 lb/msf liner contains only 20% recycled content, while the laminated product consists of 100% recycled fiber content, which is generally weaker, thereby making this result even more unexpected. FIG. 1 further provides the comparison of (b) the 2-layer laminated construct of (a) after being laminated again with a 16 lb/msf C1S litho label liner as a third layer (13+13+16=42), a 52% increase in STFI strength was measured for the 3 layer construct over that of a standard 42 lb/msf liner; Note that in FIG. 1 the CD STFI Reference Values (20% recycled content) for 1) 14 lb medium, 2) 26 lb medium and 3) 42 lb liner were obtained from the following source: R. Popil, “What's important in liner and medium physical properties”, Institute of Paper Science, Georgia Tech, Atlanta).

FIG. 1 further illustrates that less increase in strength was obtained with a petroleum based PVAc cold set adhesive, showing only a 3.2% increase in STFI strength measured for the 2 layer construct over that of a standard 26 lb/msf liner, as compared with 31% for the biopolymer adhesive formulation. Thus the biopolymer cold set adhesive formulation shows significantly improved strength vs. a petro-based PVAc cold set adhesive in this context.

Advantages of a medium or liner board construct made by laminating two flat sheets of substrate (for example paper, medium or liner) relative to a conventional medium or liner product of the same or higher weight might include one or more of less fiber used, high strength, reduced petro-plastic waste, reduced petro-based adhesive (such as PVAc glue) used, lighter weight, lower cost, the entire product recyclable or usable as a biological nutrient, attractive packaging, consumer appeal, and conventional package performance matched or exceeded.

Paper is a biodegradable, renewable, sustainable product made from trees, and from an environmental perspective it compares favorably with petroleum based packaging materials, such as plastics. Growing and harvesting trees provides jobs for millions of men and women, and working forests are good for the environment, providing clean air, clean water, wildlife habitat and carbon storage. Paper is also the most recycled material globally. Therefore, the use of paper in packaging, and especially in light weight packaging, is useful and provides a useful important industrial product.

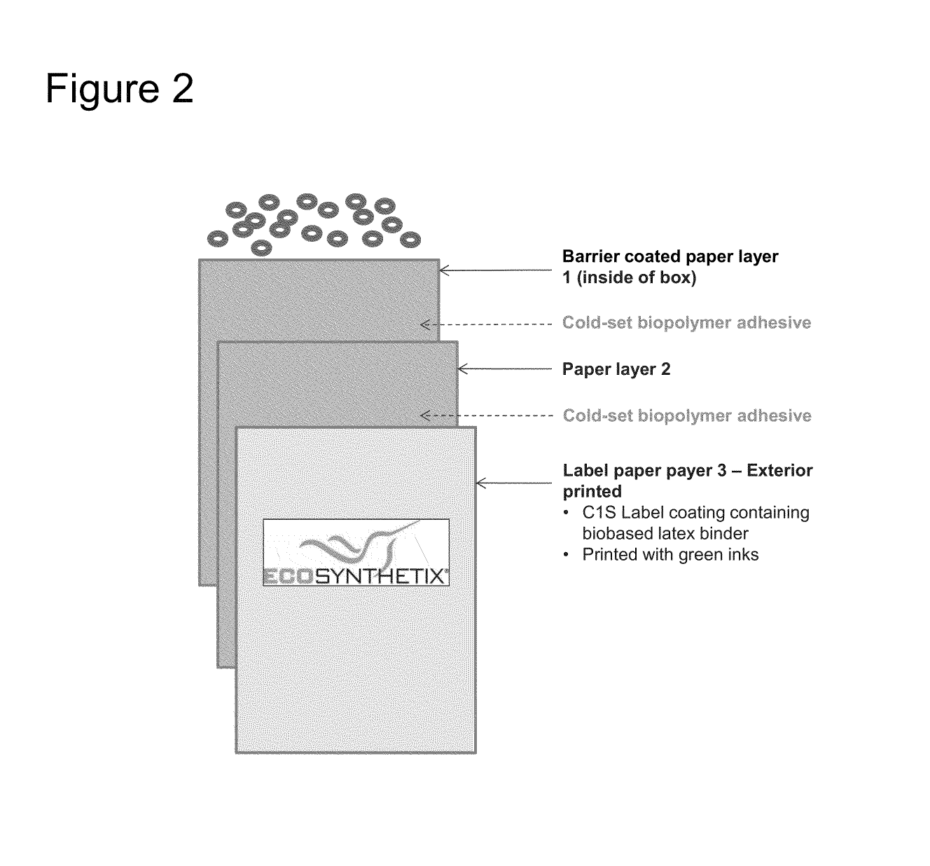

As another embodiment of the invention, using the laminated constructs of the invention, novel packaging products can be created such as the type illustrated in FIG. 2. In this case, a lighter weight cereal box design has been created, where multiple layers of paper are laminated together to create a stronger, lighter package, and where various coatings and barriers can optionally be added to enable the elimination of the interior plastic pouch. As a result the entire cereal box, with or without its content, can become fully biobased and compostable.

As another embodiment of the invention, very low dosage levels of cellulose nanocrystals (CNC) added to the, preferably, biobased laminating adhesive composition were discovered to have a major positive impact on bending stiffness. Similar observations were made for tensile strength. Without intending to be limited or bound by theory, the significant increase in the cross direction (CD) bending stiffness is believed to be the result of alignment of the high aspect ratio CNC rods in the CD direction, due to the applicator roll speed differential and the resultant wiping action created by the speed difference between the paper and the applicator roll system used to apply the aqueous adhesive composition. The increase in strength resulting from the addition of CNC can therefore be predicted to apply also to conventional laminating adhesives which may provide utility for certain applications. However, biobased adhesives that are available in dry form are particularly preferred, as they can be used to improve the rheology and boost the solids level of low solids CNC dispersions.

As another embodiment of the invention, a similar major positive impact on bending stiffness is observed for cellulose nano-fibrils (CNF) but at orders of magnitude lower loading levels. Note that two types of cellulose nano-materials used in this work were produced by US Forest Service Cellulose Nano-Materials Pilot Plant at the Forest Products Laboratory (FPL) in Madison, Wis. The Cellulose nano-crystals (CNC) are rod-like particles approximately 5 nm in diameter and 150-200 nm long. Larger crystals can be produced using cotton (10 nm by 500 nm) or algae (20 nm by 1000 nm). The FPL material is produced from wood pulp and has the smaller dimension. Cellulose nano-fibrils (CNF) as produced by FPL are string-like materials about 20 nm in diameter and 1 micron long. These are produced from bleached wood pulp using the TEMPO method which oxidizes some of the alcohol groups on the cellulose chains to carboxylic acids and uses the ionic repulsion to help separate the fibrils. TEMPO based CNF generally has a smaller average diameter and is more uniform than CNF produced using either enzyme or acid pretreatments. In addition to cellulose nanocrystals (CNC) and cellulose nanofibrils (CNF), various other types of cellulose fibrils (CF) can be used in accordance with this invention. The latter tend to be longer bundles of nanofibrils, but they have the advantage of being lower cost than CNC and CNF. The increase in strength resulting from the addition of CNF or CF can be predicted to apply also to conventional laminating adhesives which may provide utility for certain applications. However, biobased adhesives available in dry form are particularly preferred, as they can be used to improve the rheology and boost the solids level of low solids CNF and CF dispersions.

As another embodiment of this invention, any other high aspect ratio rod or fiber like nano-sized or micron-sized reinforcing materials, organic or inorganic, can be used as additives in the biobased adhesive composition to help further enhance bending stiffness and tensile strength of paper substrates. Biobased reinforcing materials are preferred. However, even without reinforcing additives, biobased adhesive compositions have been discovered that substantially enhance the strength and stiffness of medium and liner papers (see for example FIG. 1).

It is noted further that the basis weights of liner board are an artifact of history from ICC Rule 41, which included requirements that “The sum of the weight of the two liner boards for a 200-pound burst strength box shall be no less than 84 pounds per 1000 square feet,” etc., which resulted in the standard weights of liner board and medium. Rule 41 was changed in 1993 to eliminate the burst test requirements and switch to edge crush specifications, including Short-Span Compression Test (SCT or CD-STFI) and Ring Crush. The requirements on basis weight were also eliminated, but the “standards” continue to exist in North America (NA). They are no longer used in the rest of the world. Notably box and containerboard weights in Europe and the rest of the world are generally about 25-30% lighter than equivalent stacking strength in NA. North American containerboard machines are not capable of making lighter basis weights and meeting customer desires for lighter weight packaging. The present invention therefore could help facilitate NA in becoming more competitive in global markets, and could help facilitate conversion of printing and writing paper machines, including newsprint, to containerboard production and participation in higher growth and higher value packaging applications.

This specification describes, among other things, cold-set biobased laminating adhesive compositions, comprising aqueous formulations of biopolymers, optionally with alkaline additives, optionally fortified with high-aspect-ratio inorganic and organic fillers, fibers and nanofibers, optionally with barrier-inducing additives, in which the cold-set biobased laminating adhesive composition can optionally be used to create stronger (for a given weight) liner and medium paperboard products for light-weight paperboard and corrugated boxboard materials that have enhanced strength and barrier properties as compared with similar or heavier weight paperboard products produced using traditional manufacturing methods. These high-strength light-weight paperboard and corrugated boxboard materials can be used, for example, as light weight packaging materials that are fully compatible with paper recycling and composting operations.

Although biobased adhesives are preferred, some aspects of the invention may also be applied to conventional laminating adhesives. These aspects include, for example, the use of high aspect ratio rod or fiber like nano-sized or micron-sized reinforcing materials, organic or inorganic, as an additives in the adhesive composition, preferably to enhance bending stiffness and/or tensile strength of a laminated structure. Another such aspect is the creation of a material usable in the manner of medium or liner board of 26 lb/msf or more by laminating two or more sheets of a substrate each of up to about 26 lb/msf.

The word “preferable” and variants thereof is used to indicate that a feature is optional, however the feature may have one or more attributes that make it useful or advantageous over other options in one or more circumstances.

### EXAMPLES

The following examples are intended to further serve to illustrate the invention. They are not in any way intended to limit the scope of the invention. Nanoparticles other than those made in accordance with U.S. Pat. No. 6,677,386 or purchased from EcoSynthetix could be used. For example, other so-called “regenerated” nanoparticles, wherein a native biopolymer is processed and regenerated into particles of less than 2500 nm, or less than 1000 nm, might be used. Other forms of cold soluble (i.e. chemically modified) starches or dextrins might be used. In some cases, even a conventional laminating adhesive might be used, although this is not preferred.

### Example 1

A biobased adhesive composition was prepared by adding 7.75 g (i.e. 7.29 g on a dry basis) of biopolymer nanoparticles powder agglomerate (EcoSphere® X202 from EcoSynthetix Inc.; exp. solids=94.0% using CEM Smart System 5 Microwave Dryer at 120° C. for 5 mins) to 20.8 g of room temperature water containing 0.12 g sodium carbonate, followed by 0.54 g of Acticide™ GA (a biocide from Thor Chemicals). The agglomerate powder was fully dispersed within 15 mins under mechanical shear using a lab turbine mixer to obtain the 25 wt % dispersion. The pH was 9.2 and the RVII Brookfield viscosity was 350 cps at 20° C. (100 rpm spindle speed).

### Example 2

A biobased adhesive composition was prepared by adding 7.75 g (i.e. 7.29 g on a dry basis) of biopolymer nanoparticles powder agglomerate (EcoSphere® X202 from EcoSynthetix Inc.; exp. solids=94.0% using CEM Smart System 5 Microwave Dryer at 120° C. for 5 mins) to 28.4 g of cellulose nanocrystals (CNC) (provided by Forest Products Laboratories, Madison, Wis., prepared by using a sulfuric acid process, Lot number 2012-FPL-CNC-043; exp. solids=6.8% using CEM Smart System 5 Microwave Dryer at 120° C. for 5 mins), followed by 0.12 g sodium carbonate and 0.54 g of Acticide™ GA (Thor Chemicals). The agglomerate powder was fully dispersed within 15 mins under mechanical shear using a lab turbine mixer to obtain the 25 wt % dispersion. The pH was 8.3 and the RVII Brookfield viscosity was 1000 cps at 20° C. (100 rpm spindle speed).

### Example 3

A biobased adhesive composition was prepared by adding 7.75 g (i.e. 7.29 g on a dry basis) of biopolymer nanoparticles powder agglomerate (EcoSphere® X202 from EcoSynthetix Inc.; exp. solids=94.0% using CEM Smart System 5 Microwave Dryer at 120° C. for 5 mins) to 28.4 g of cellulose nanofibrils (CNF) (provided by Forest Products Laboratories, Madison, Wis., prepared by using a TEMPO-oxidation process, Lot number 2012-FPL-CNF-040; exp. solids=0.75% using CEM Smart System 5 Microwave Dryer at 120° C. for 5 mins), followed by 0.12 g sodium carbonate and 0.54 g of Acticide™ GA (Thor Chemicals). The agglomerate powder was fully dispersed within 15 mins under mechanical shear using a lab turbine mixer to obtain the 25 wt % dispersion. The pH was 6.6 and the RVII Brookfield viscosity was 1620 cps at 20° C. (100 rpm spindle speed).

### Example 4A

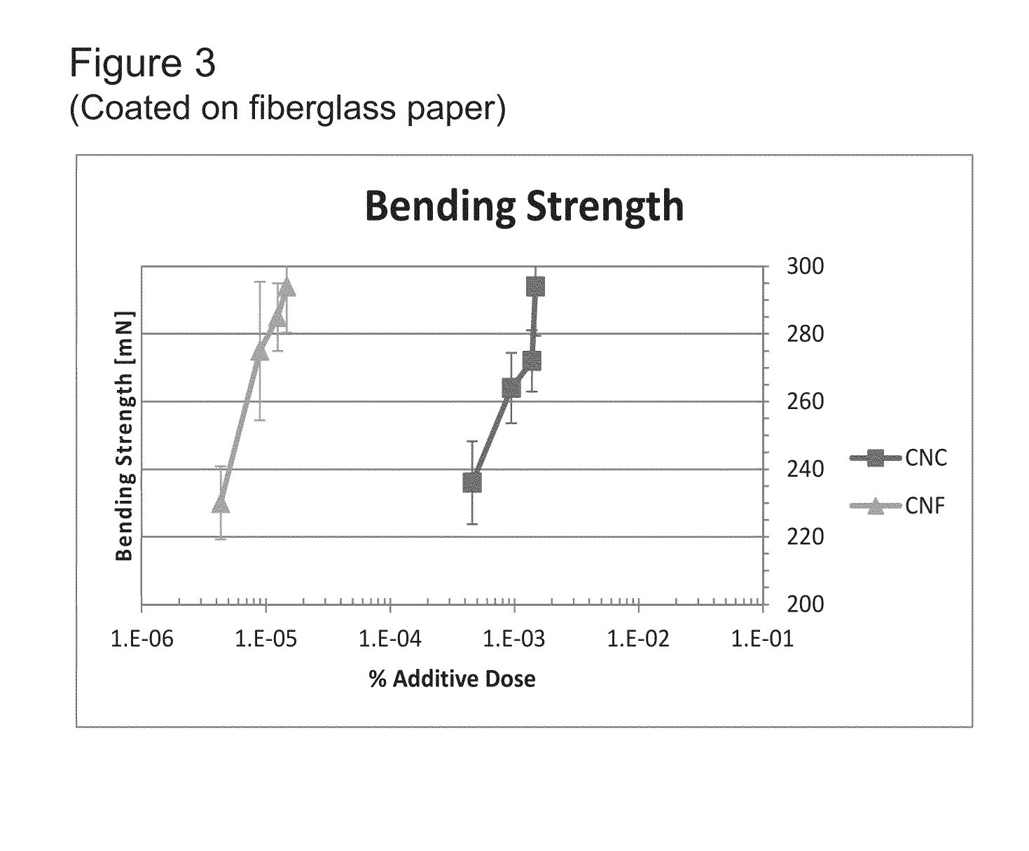

The biobased adhesive compositions of Examples 1, 2 and 3 were coated onto fiberglass paper and subsequently dried and equilibrated at room temperature for 24 hours. Dilutions were made as necessary, to attain the loading levels (coat weights) in Table 1 and FIG. 3. The advantage of using fiberglass paper is that the coat weight can be confirmed via a standard “Loss-On-Ignition” method, given that the glass fiber is stable under the oven ignition conditions at 550° C., whereas the organic coating is burned off and lost such that the coat weight can be accurately determined. Loss on ignition (LOI) means the percent decrease in weight of fiberglass after it has been ignited. The LOI is used to monitor the weight percent of binder in fiberglass paper and fiberglass bats. The calculation of LOI is as follows: % LOI=[(pre-ignition weight−post-ignition weight)/pre-ignition weight]×100. The procedure is described in ASTM D 2584 for Ignition Loss of Cured Reinforced Resins. According to this ASTM LOI is determined on cured fiberglass samples by igniting it in a muffle furnace at 550° C., keeping at this temperature for 5 min, cooling in desiccator, and weighing (before and after ignition). The test is reported as an average of triplicate measurements. The bending stiffness was measured using a Messmer Büchel Bending Resistance tester. The test result is reported as an average of ten measurements. The detailed procedure is as follows:
1. Obtain a sample of the paper or paperboard in accordance with TAPPI T400 “Sampling and Accepting a Single Lot of Paper, Paperboard, Containerboard, or Related Product.”
2. Precondition then condition the sample in accordance with TAPPI T 402 “Standard Conditioning and Testing Atmospheres for Paper, Board, Pulp Handsheets, and Related Products.”
3. From each sample cut 20 specimens, 10 with the long edge parallel to the machine, and 10 with the long edge parallel to the cross direction. The samples should be cut by 38±0.1 mm×76 mm
4. Turn on the power. Allow the instrument to be warm up 15 minutes.
5. Turn on the compressed air. Adjust the reading of pressure gauge to 4 bar.
6. From instrument display press “1” to select unit of reading. After selecting “1”, press “1”, ‘2” or “3” for “mN”, “Nmm” or “Tabber” respectively.)
7. After the measuring unit is set, press “2” on the instrument display to set bending angle. Note that the actual bending angle to be used is the entered value multiplied by 0.1. For example, if 15 degree bending angle is required, 150 should be pressed.
8. After bending angle is chosen, press “3” to select bending length. After pressing “3”, use “1”, “2”, “3”, “4”, “5” or “6” for selecting bending length “5 mm”, “10 mm”, “15 mm”, “20 mm”, “25 mm” or “50 mm” respectively.)
9. Insert the sample into the clamp.
10. Press the start to make the measurement and write down the reading.
11. Use each specimen only once. Test 10 specimens in the cross machine and 10 in the machine direction. For each direction test 5 specimens toward the wire side and 5 toward the felt side.
12. Machine direction bending resistance is the bending resistance of a specimen, clamped with its machine direction perpendicular to the line of clamping. Cross direction bending resistance is the bending resistance of a specimen, clamped with its cross direction perpendicular to the line of clamping.
Additional Info.
TAPPI T556 om-11 “Bending resistance of paper and paperboard by single-point bending method”.

The results in FIG. 3 demonstrate that very low dosage levels of CNC have a major positive impact on bending stiffness. Similar observations were made for tensile strength. Further noteworthy, is that the same is observed for CNF but at two orders of magnitude lower loading levels. Note that the two types of cellulose nano-materials used in this work were produced by US Forest Service Cellulose Nano-Materials Pilot Plant at the Forest Products Laboratory (FPL) in Madison, Wis. The Cellulose nano-crystals (CNC) are rod-like particles approximately 5 nm in diameter and 150-200 nm long. Larger crystals can be produced using cotton (10 nm by 500 nm) or algae (20 nm by 1000 nm). The FPL material is produced from wood pulp and has the smaller dimension. Cellulose nano-fibrils (CNF) as produced by FPL are string-like materials about 20 nm in diameter and 1 micron long. These are produced from bleached wood pulp using the TEMPO method which oxidizes some of the alcohol groups on the cellulose chains to carboxylic acids and uses the ionic repulsion to help separate the fibrils. TEMPO based CNF generally has a smaller average diameter and is more uniform than CNF produced using either enzyme or acid pretreatments. In principle any other high aspect ratio rod or fiber like nano-sized or micron-sized reinforcing materials, organic or inorganic, can be used as additives in the biobased adhesive composition to help further enhance bending stiffness and tensile strength of paper substrates. Biobased reinforcing materials are preferred. However, even without reinforcing additives, biobased adhesive compositions have been discovered that substantially enhance the strength and stiffness of medium and liner papers (see for example FIG. 1).

### Example 48

A biobased adhesive composition was prepared by adding 2422 g (i.e. 2277 g on a dry basis) of biopolymer nanoparticles powder agglomerate (EcoSphere® X202 from EcoSynthetix Inc.; exp. solids=94.0% using CEM Smart System 5 Microwave Dryer at 120° C. for 5 mins) to 15375 g of room temperature water, followed by 27 g of Acticide™ GA (a biocide from Thor Chemicals). The agglomerate powder was fully dispersed within 15 mins under mechanical shear using a Cowles mixer. The % solids was measured at 22.0%, the pH was 4.0 and the RVII Brookfield viscosity was 124 cps at 20° C. (100 rpm spindle speed).

### Example 5

A biobased adhesive composition was prepared by adding 6110 g of cellulose nanocrystals (CNC) (provided by Forest Products Laboratories, Madison, Wis., using a sulfuric acid process Lot number 2013-FPL-CNC-049; exp. solids=10.1% using CEM Smart System 5 Microwave Dryer at 120° C. for 5 mins) to 1930 g of room temperature water, followed 1666 g (i.e. 1566 g on a dry basis) of biopolymer nanoparticles powder agglomerate (EcoSphere® X202 from EcoSynthetix Inc.; exp. solids=94.0% using CEM Smart System 5 Microwave Dryer at 120° C. for 5 mins) and then followed by 27 g of Acticide™ GA (Thor Chemicals). The agglomerate powder was fully dispersed within 15 mins under mechanical shear using a Cowles mixer. The % solids was measured at 22.0%, the pH was 4.0 and the RVII Brookfield viscosity was 230 cps at 25° C. (100 rpm spindle speed).

### Example 6

The biobased adhesive compositions of Examples 4 and 5 were coated onto a 26 lb liner using a 13″ wide (12″ wide coating surface) pilot coater facility at a speed of 150 ft/min. A rod coater equipped with a No. 14 grooved rod and a rubber applicator roll was used to apply a controlled coat weight. The coat weight was determined by weighing the total amount of wet adhesive deposited over 1000 square feet of paper. The coat weights were later confirmed by the CEM SmartSystem 5 method for 100 cm² paper circles. Using this method, the mass of uncoated and coated sheets were determined as the average of triplicate measurements by cutting samples using a 100 cm² circular paper cutter. The dry weight of coated and uncoated samples for the 100 cm² paper circles was determined using the CEM SmartSystem 5.

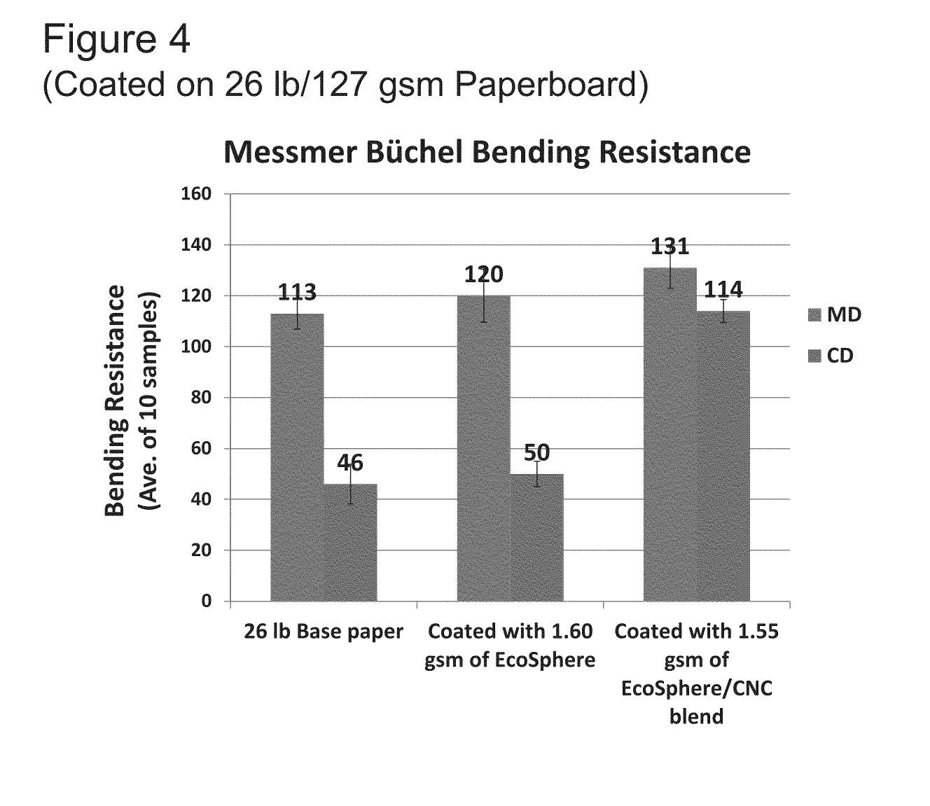

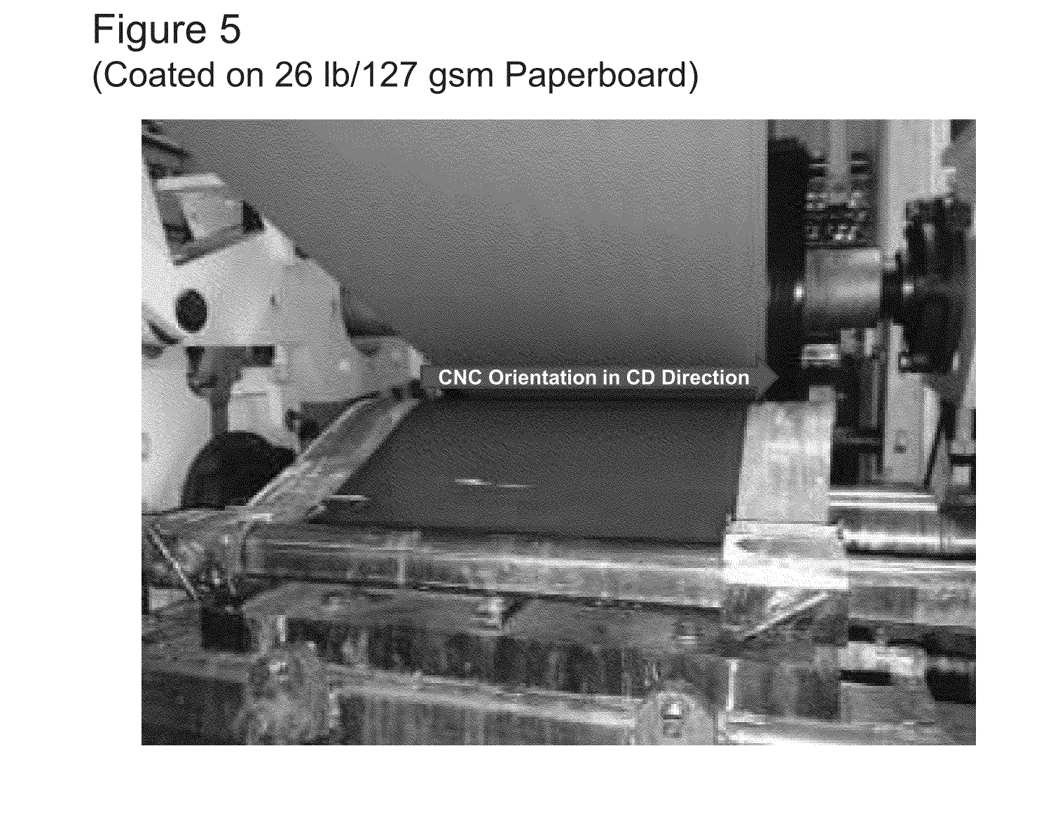

1. The pilot coater facility was designed to consistently deliver (measurable and controllable) coat weights. Very low coat weights of 1.60±0.05 gsm dry basis were confirmed using the CEM SmartSystem 5 method. The low coat weights were especially important given the relatively high cost of CNC, and given that only very low levels are required for substantial enhancements of paper strength and stiffness (see Example 3 and the results in FIG. 3). FIG. 4 shows the results for the uncoated paper (FIG. 4, left), the biobased adhesive of Example 4 coated at 1.60 gsm (FIG. 4, middle), and the biobased adhesive of Example 5 containing CNC coated at 1.55 gsm (FIG. 4, right), measured using a Messmer Büchel Bending Resistance tester. The test result is reported as an average of ten measurements. Whereas the Messmer Büchel Bending Resistance test is less sensitive that the STFI test, the results demonstrate a huge increase in bending stiffness in the paper cross direction (CD). The CD strength is always lower than the MD (machine direction) strength for fine paper, medium and liner board, due to fiber alignment in the MD direction. As a result, for board and packaging performance, the CD strength is of greatest importance. Without intending to be limited or bound by theory, the huge increase in the CD bending stiffness is believed to be the result of alignment of the high aspect ratio CNC rods in the CD direction, due to the purposely controlled applicator roll speed differential and the resultant wiping action created by the speed difference between the paper and the applicator roll system used to apply the aqueous adhesive composition, as illustrated in FIG. 5.

### Example 7

As noted in Example 3, biobased adhesive compositions have been discovered without the use of reinforcing additives that substantially enhance the strength and stiffness of medium and liner papers. A biobased adhesive composition was prepared by adding 5114 g (i.e. 1923 g on a “bone dry” basis) of sodium silicate (sodium silicate N grade from National Silicates; the exp. solids=43.0% using CEM Smart System 5 Microwave Dryer at 150° C. for 5 mins; the bone dry solids=37.6%) to 8982 g of warm water, followed by 4545 g (i.e. 4273 g on a dry basis) of biopolymer nanoparticles powder agglomerate (EcoSphere® X202 from EcoSynthetix Inc.; exp. solids=94.0% using CEM Smart System 5 Microwave Dryer at 120° C. for 5 mins). The agglomerate powder was fully dispersed within 15 mins under mechanical shear using an AME high shear mixer (note that turbine, Kady or Cowles type mixers may also be used; mixing times may vary to reach complete dispersion). Finally 545 g of 10% caustic was added. The RVII Brookfield viscosity was 350 cps at 25° C. (100 rpm spindle speed). The final pH was 11.3. Without intending to be limited or bound by theory, the alkaline pH is believed to help swell the paper fibers to ensure fast set at high commercial laminating line speeds.

### Example 8

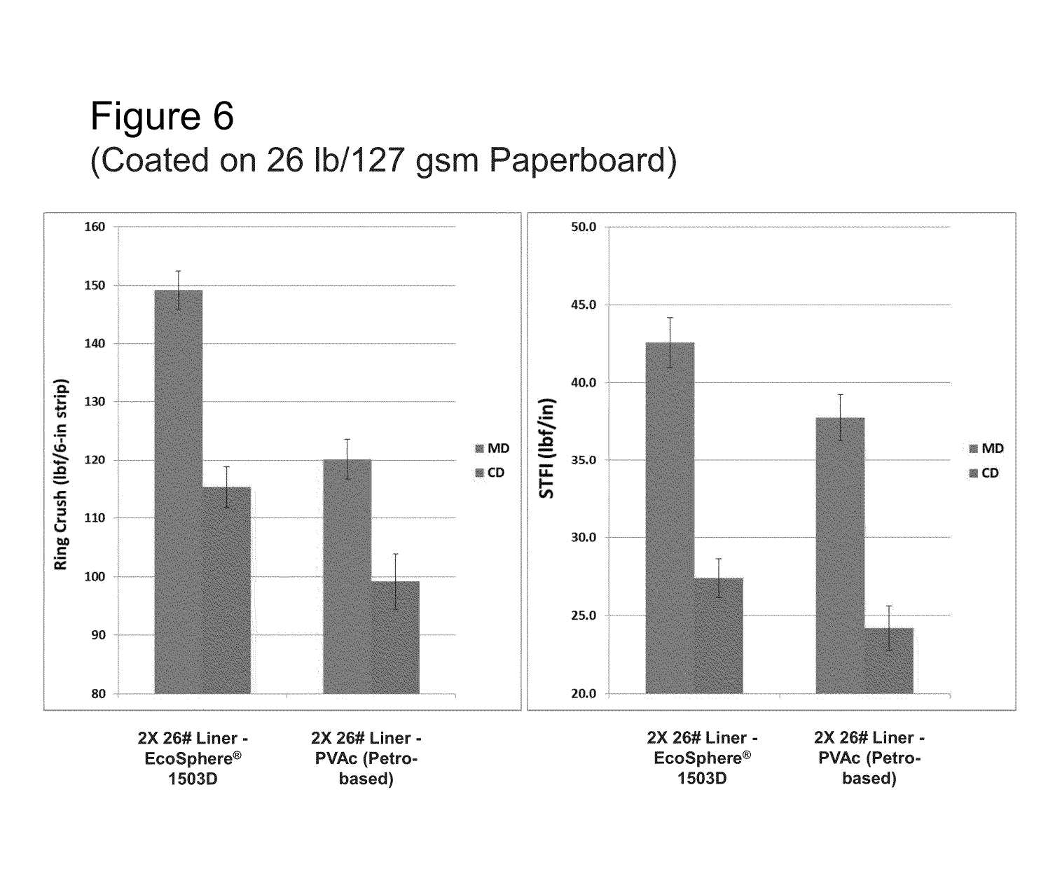

The biobased adhesive composition of Example 7, as well as a petroleum based PVAc white glue (% solids=40%), were coated onto a 26 lb liner using a 13″ wide (12″ wide coating surface) pilot coater facility at a speed of 200 ft/min. A rod coater equipped with a No. 24 grooved rod and a rubber applicator roll was used to apply a controlled coat weight. The coated 26 lb liner was mated to a second 26 lb liner to produce the laminated construct which was taken up on a wind-up reel without the addition of external heat or passing through a heated section. Immediately following winding the laminated construct exhibited 100% fiber tear. The coat weight was determined by weighing the total amount of wet adhesive deposited over 1000 square feet of paper. The coat weights were later confirmed by the CEM SmartSystem 5 method to be in the range of 12-17 gsm. The strength of the laminated constructs was measured by 1) STFI, Short-Span Compression Strength TAPPI Method T826, and 2) Ring Crush as determined by TAPPI Method T822. Both these test results are reported as an average of ten measurements. FIG. 6 shows the results for the 2 layer laminated constructs made using the biobased adhesive composition of Example 7 and the PVAc white glue. Of noticeable importance is the higher strength observed for laminated constructs made using the biobased adhesive composition.

### Example 9A

The biobased adhesive composition of Example 7, as well as a petroleum based PVAc white glue (% solids=40%), were coated onto a 13 lb liner using a 13″ wide (12″ wide coating surface) pilot coater facility. A rod coater equipped with a No. 24 grooved rod and a rubber applicator roll was used to apply a controlled coat weight. The coated 13 lb liner was mated to a second 13 lb liner to produce the laminated construct which was taken up on a wind-up reel without the addition of external heat or passing through a heated section. Immediately following winding the laminated construct exhibited 100% fiber tear. The coat weight was determined by weighing the total amount of wet adhesive deposited over 1000 square feet of paper. The coat weights were later confirmed by the CEM SmartSystem 5 method to be 8.18 and 8.32 gsm, respectively, for the laminated constructs made using the biobased adhesive composition of Example 7 and the PVAc white glue. The strength of the single sheets and the laminated constructs was measured by STFI, Short-Span Compression Strength TAPPI Method T826. The test result is reported as an average of ten measurements. FIG. 1 shows the results for the 2 layer laminated constructs made using the biobased adhesive composition of Example 7 and the PVAc white glue. Of noticeable importance is the higher strength observed for laminated constructs made using the biobased adhesive composition. FIG. 1 further provides a comparison of the Short-Span Compression Strength (STFI value) for (a) one sheet of 100% recycled medium (13 lb/msf) with two of the same sheets after being laminated with a biopolymer adhesive formulation of the invention. The results show a similar strength value of the 100% recycled medium (13 lb/msf) to a standard 14 lb/msf medium, but when 2 13 lb/msf sheets were laminated (13+13=26) a 31% increase in STFI strength was measured for the 2 layer construct over that of a standard 26 lb/msf liner. Note further that the standard 26 lb/msf liner contains only 20% recycled content, while the laminated product consists of 100% recycled content, which is generally weaker making this result even the more unexpected. FIG. 1 further provides the comparison of (b) the 2-layer laminated construct of (a) after being laminated again with a 16 lb/msf C1S litho label liner as a third layer (13+13+16=42), a 52% increase in STFI strength was measured for the 3 layer construct over that of a standard 42 lb/msf liner; Note that in FIG. 1 the CD STFI Reference Values (20% recycled content) for 1) 14 lb medium, 2) 26 lb medium and 3) 42 lb liner were obtained from the following source: R. Popil, “What's important in liner and medium physical properties”, Institute of Paper Science, Georgia Tech, Atlanta); Note that STFI is a key measure used in the industry to measure product strength.

FIG. 1 further illustrates that no substantial increase in strength was obtained with a petroleum based PVAc cold set adhesive, showing only a 3.2% increase in STFI strength measured for the 2 layer construct over that of a standard 26 lb/msf liner, as compared with 31% for the biopolymer adhesive formulation of Example 7. Thus the biopolymer cold set adhesive formulation shows significantly improved strength vs. a petro-based PVAc cold set adhesive.

### Example 9B

The biobased adhesive composition of Example 7 was coated onto a 13 lb liner using a 13″ wide (12″ wide coating surface) pilot coater facility. A rod coater equipped with a No. 24 grooved rod and a rubber applicator roll was used to apply a controlled coat weight. The coated 13 lb liner was mated to a second 13 lb liner to produce the laminated construct which was taken up on a wind-up reel without the addition of external heat or passing through a heated section. Immediately following winding the laminated construct exhibited 100% fiber tear. The coat weight was determined by weighing the total amount of wet adhesive deposited over 1000 square feet of paper. The coat weight was later confirmed by the CEM SmartSystem 5 method to be 8.20 gsm. Given that laminated paper, medium and liner can be subsequently used in conventional heated corrugating operations to produce stronger and/or lighter weight corrugated box products as described in this invention, the impact of heat-induced curing on board strength was determined. Therefore, sheets of the laminated product produced in this example were tested before and after curing at 180° C. for 1 minute (which is the typical temperature of the hot plates section in the double backer corrugating process). The strength of the uncured and cured laminated constructs was measured by STFI, Short-Span Compression Strength TAPPI Method T826. The test result is reported as an average of ten measurements. A minimum 7% increase in STFI was found for the cured laminated constructs over the uncured samples (see Table 3). Similar results were consistently found for all of the other laminated board constructs using the biobased adhesive. In contrast, no significant increases upon curing were observed for the PVAc white glue. Without intending to be limited or bound by theory, the increase in the strength after being exposed to the typical heat conditions in corrugating is believed to be the result of a loss of a finite amount of bound water from the adhesive to result in a stronger and more rigid construct. This discovery (of increased strength) should be confirmed for the laminated constructs of the present invention using a commercial corrugating operation, some of which have typical cure times are on the order of 5-15 seconds at 180° C., but suggests that there should at least be no loss in laminating strength in a commercial corrugating operation.

### Example 10

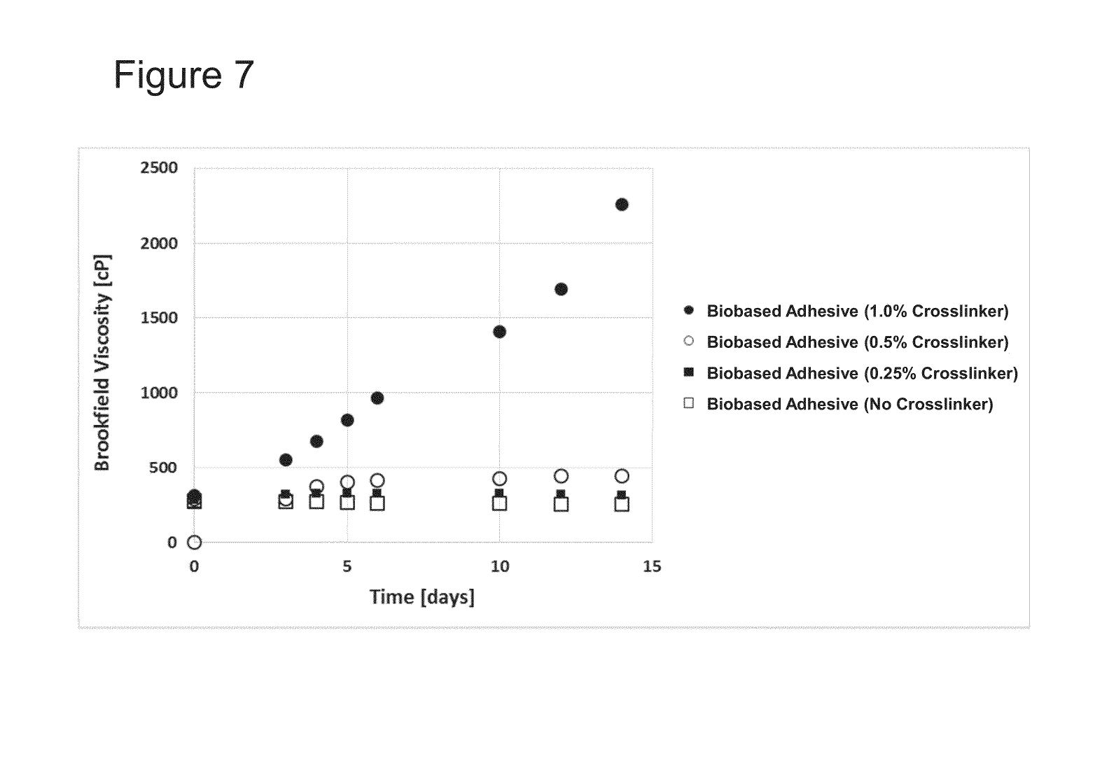

To the biobased adhesive composition of Example 7, an epoxy based crosslinker was added. Samples of laminated constructs produced with the biobased adhesive containing 0.5 to 1 wt % of epoxy resin GE 40 (Dow Chemicals) based on the total weight of the wet adhesive formulation, after curing, passed a 24 hour soak test in room temperature water. The samples were cured at 180° C. for 1 minute (the typical temperature of the hot plates section in the double backer corrugating process). Samples containing 0.25 wt % of epoxy resin GE 40 (Dow Chemicals) based on the total weight of the wet adhesive formulation did not pass a 24 hour soak test in room temperature water. Samples containing no epoxy resin crosslinker also failed the soak test. Very similar results were obtained for GE 40 and D.E.R. 732 (Dow Chemical). Samples containing more than 0.5% crosslinker built viscosity upon storage, as illustrated in FIG. 7. Therefore, the preferred range of epoxy crosslinker is 0.5 to 1.0%.

TABLE 1
Coating of Biobased Adhesive Compositions Containing Biopolymer
Nanoparticles and Either CNC or CNF onto Fiberglass Paper:

| | % | % | % Additive | % Additive | % Additive |
|---|---|---|---|---|---|
| | Solids | Loading | solids as is | dose as is | dose dry basis |
| Experi- | [g | [g | [g additive | [g additive | [g additive |
| ment | solids/g | recipe/g | dry/g | as is/g | dry/g |
| units | recipe] | support] | additive as | support] | support] |
| CNC | 7.40% | 43.22% | 6.81% | 0.67% | 0.045714% |
| CNC | 10.44% | 63.13% | 6.81% | 1.38% | 0.094214% |
| CNC | 12.36% | 78.17% | 6.81% | 2.03% | 0.138115% |
| CNC | 12.92% | 80.00% | 6.81% | 2.17% | 0.147748% |
| CNF | 7.57% | 44.50% | 0.67% | 0.06% | 0.000433% |
| CNF | 10.44% | 66.67% | 0.67% | 0.13% | 0.000894% |
| CNF | 12.27% | 78.79% | 0.67% | 0.19% | 0.001242% |
| CNF | 13.31% | 86.00% | 0.67% | 0.22% | 0.001470% |
| Control | 7.57% | 43.28% | 0.00% | 0.00% | 0.00% |
| Control | 10.26% | 62.63% | 0.00% | 0.00% | 0.00% |
| Control | 12.40% | 76.12% | 0.00% | 0.00% | 0.00% |
| Control | 13.45% | 84.08% | 0.00% | 0.00% | 0.00% |

TABLE 2
Comparison of Strength of the Single Sheets and the Laminated Constructs
as measured by STFI, Short-Span Compression Strength (TAPPI Method T826):

| | Laminated | No. of | MD STFI | St. Dev. | CD STFI | St. Dev. | % CD |
|---|---|---|---|---|---|---|---|
| Paper Samples | Construct | Sheets | (lbf/in) | (Ave. of 10) | (lbf/in) | (Ave. of 10) | Improvement |
| 1X 13# (lb/msf) Recycled Medium Paper | No | 1 | 10.9 | 0.9 | 5.3 | 0.4 | n/a |
| 1X 16# White Top C1S Litho Label | No | 1 | 11.0 | 0.7 | 9.6 | 0.9 | n/a |
| 2X 13# Recycled Medium PVAc (Petro-based) | Yes | 2 | 26.7 | 0.8 | 14.0 | 0.8 | 3.2% |
| 2X 13# Recycled Medium EcoSphere ® 1503D | Yes | 2 | 32.7 | 0.5 | 17.8 | 1.5 | 31.4% |
| 2X 13# Recycled + 1X 16# White Top EcoSphere ® 1503D | Yes | 3 | 53.8 | 1.8 | 34.1 | 1.4 | 51.9% |

TABLE 3
Comparison of Strength Laminated Constructs Before
and After Heat Cure as measured by STFI, Short-Span
Compression Strength (TAPPI Method T826):

| | Before Heat | | After Heat | | % | |
|---|---|---|---|---|---|---|
| | Cure | | Cure | | Increase | |
| Laminated Construct Sample | MD | CD | MD | CD | MD | CD |
| 2X 13# Recycled Medium | 28.4 | 16.6 | 32.7 | 17.8 | 15% | 7% |
| EcoSphere ® 1503D | | | | | | |
| 2X 13# Recycled + 1X 16# | 46.8 | 31.2 | 53.8 | 34.1 | 15% | 9% |
| White Top EcoSphere ® 1503D | | | | | | |
| (3 layers) | | | | | | |

We claim:

1. A laminated construct comprising two or more layers of substrate adhered to one another, each layer of substrate being 26 lb/msf or less.

2. The laminated construct of claim 1, where the strength of the construct is measured by Ring Crush as determined by TAPPI Method T822 or Short-Span Compression Strength as determined by TAPPI Method T826 and exceeds the strength of a comparable weight but non-laminated liner board.

3. The laminated construct of claim 1, comprising a laminating adhesive composition, the laminating adhesive composition comprising an aqueous formulation comprising one or more biopolymers.

4. The laminated construct of claim 3, wherein the laminating adhesive composition comprises biopolymer nanoparticles.

5. The laminated construct of claim 3, wherein the laminating adhesive composition comprises one or more alkaline additives.

6. The laminated construct of claim 3, wherein the laminating adhesive composition comprises one or more high-aspect-ratio inorganic or organic fillers, fibers or nanofibers.

7. The laminated construct of claim 3, wherein the laminating adhesive comprises barrier-inducing additives.

8. The laminated construct of claim 1, wherein the laminated construct is produced by laminating two or more sheets of paper, medium or linerboard each equal to or less than 16, 18 or 20 lb/msf.

9. The laminated construct of claim 8, wherein the sheets are at least 4 lb/msf.

10. The laminated construct of claim 8, wherein the sheets range from 8 to 16 lb/msf.

11. The laminated construct of claim 1, wherein the laminated construct is produced by laminating one or more layers of paper, medium and liner board with a C1S (Coated One Side) label paper or other printable substrate as the top and/or bottom layer.

12. The laminated construct of claim 11, where the C1S label paper or other printable substrate is designed for one or more of offset printing, digital printing or flexo printing.

13. The laminated construct of claim 3, wherein the laminating adhesive composition is a cold-set adhesive.

14. An adhesive composition comprising an aqueous formulations comprising one or more biopolymers and a) one or more alkaline additives, or b) one or more high-aspect-ratio inorganic or organic fillers, fibers or nanofibers, or c) one or more barrier-inducing additives.

15. The adhesive compound of claims 14, wherein the alkaline additives are selected from the group consisting of sodium carbonate, sodium hydroxide, sodium silicate, potassium hydroxide, ammonium hydroxide, calcium oxide, calcium hydroxide, calcium magnesium oxide, calcium magnesium hydroxide, sodium aluminum oxide, hydrated lime, dolomitic lime, dolime and any other natural alkaline mining materials.

16. The adhesive compound of claim 14, comprising one or more high-aspect-ratio inorganic or organic fillers, fibers or nanofibers.

17. The adhesive compound of claim 14, wherein the additives are selected from the group consisting of cellulose nanocrystals (CNC), cellulose nanofibrils (CNF) and cellulose fibrils (CF).

18. The adhesive compound of claim 14, where the barrier-inducing additives are selected from the group consisting of crosslinkers, hydrophobizers and inorganic and organic barrier materials.

19. An adhesive composition comprising one or more high-aspect-ratio inorganic or organic fillers, fibers or nanofibers.

20. The adhesive composition of claim 19, wherein the one or more high-aspect-ratio inorganic or organic fillers, fibers or nanofibers comprise a material selected from the group consisting of cellulose nanocrystals (CNC), cellulose nanofibrils (CNF) and cellulose fibrils (CF).
